(19) United States
(12) Patent Application Publication
(10) Pub. No.: US 2026/0161952 A1
(43) Pub. Date: Jun. 11, 2026

(54) ARTIFICIAL INTELLIGENCE DEVICE FOR MIXTURE-OF-OPINIONS WITH FINE-TUNING AND METHOD THEREOF

(71) Applicant: LG ELECTRONICS INC., Seoul (KR)

(72) Inventors: Yanan CHEN, Toronto (CA); Ali PESARANGHADER, Toronto (CA)

(73) Assignee: LG ELECTRONICS INC., Seoul (KR)

(21) Appl. No.: 19/415,493

(22) Filed: Dec. 10, 2025

Related U.S. Application Data
(60) Provisional application No. 63/730,934, filed on Dec. 11, 2024.

(51) Int. Cl. G06N 3/09; G06N 3/0475; G06N 3/096

(52) U.S. Cl. CPC G06N 3/09; G06N 3/0475; G06N 3/096

(57) ABSTRACT

A method for controlling an artificial intelligence (AI) device can include receiving a query, obtaining a plurality of ancillary opinions generated by a plurality of ancillary language models in response to the query, in which each of the plurality of ancillary opinions includes a chain-of-thought reasoning path derived by a corresponding one of the plurality of ancillary language models and an answer to the query, constructing an aggregated input sequence including the query and the plurality of ancillary opinions, and generating, by a fine-tuned main large language model, a final response based on the aggregated input sequence. Also, the fine-tuned main large language model is fine-tuned to synthesize the plurality of ancillary opinions to derive the final response.

### CROSS-REFERENCE TO RELATED APPLICATIONS

This non-provisional application claims priority under 35 U.S.C. § 119 (e) to U.S. Provisional Application No. 63/730,934, filed on Dec. 11, 2024, the entirety of which is hereby expressly incorporated by reference into the present application.

### BACKGROUND

### Field

The present disclosure relates to a device and method for enhancing the reasoning capabilities of large language models (LLMs), in the field of artificial intelligence (AI). Particularly, the method can implement a framework for fine-tuning a primary large language model on a training dataset augmented with a plurality of opinions generated by ancillary language models to improve reasoning.

### Discussion of the Related Art

Artificial intelligence (AI) has seen significant advancements, particularly with the development of Large Language Models (LLMs) capable of understanding and generating human like text. While these models excel at many tasks, their proficiency in areas requiring complex, multi-step logical reasoning remains a significant challenge. The reliability of LLMs for such tasks is often inconsistent and limits their deployment in applications where accuracy and verifiable reasoning are desired.

For example, a notable performance gap exists between very large, proprietary models and smaller, more accessible open source models. The superior reasoning capabilities of large, proprietary models are typically the result of massive computational resources and extensive training on vast datasets, which may make them prohibitively expensive to develop and operate for many enterprises.

Also, a persistent problem in existing LLMs is their tendency to hallucinate or generate flawed reasoning steps. This unreliability in the process undermines user trust and makes the models unsuitable for demanding domains, such as scientific research, financial analysis, or engineering. Existing fine-tuning methods, such as standard Supervised Fine-Tuning (SFT), often fail to address this issue as they primarily teach the model to mimic a single correct answer pattern rather than exposing the model to a diverse range of possible approaches.

Thus, a need exists for an improved method that can enhance the logical reasoning of a language model by fine-tuning it on a dataset enriched with a diverse plurality of problem solving opinions, which can improve its reasoning capabilities and final answer accuracy without requiring cost prohibitive computational resources.

Furthermore, a need exists for a comprehensive framework that can systematically improve the mathematical and logical reasoning of large language models. Such a method is needed to improve training by exposing a primary model to a diverse set of reasoning methodologies to provide more robust and reliable problem solving capabilities.

### SUMMARY OF THE DISCLOSURE

The present disclosure has been made in view of the above problems and it is an object of the present disclosure to provide a device and method that can improve the reasoning capabilities of large language models (LLMs). Further, the method can provide enhanced reasoning by implementing a framework in which a primary LLM is fine-tuned on a training dataset that has been augmented with a mixture of opinions (e.g., a MoO approach).

An object of the present disclosure is to provide an artificial intelligence (AI) device and method for enhancing the mathematical and logical reasoning capabilities of a large language model (LLM). The method can utilize a multi-stage framework to improve a primary LLM's problem solving abilities. For example, a data augmentation stage can first process a training dataset and for each question or sample therein, generate a plurality of opinions (e.g., a mixture of opinions MoO) from one or more ancillary LLMs, in which each opinion can include a set of reasoning steps and a final answer. Then, in a fine-tuning stage, the primary LLM can be fine-tuned on the augmented dataset which can include the generated opinions being inserted between the original question and the ground truth solution. Further, during an inference stage, when presented with a new question, a plurality of new opinions can be generated by the ancillary LLMs and provided as context to the fine-tuned primary LLM to consider which then can generate a final, more accurate answer. This process can produce a primary LLM with significantly improved reasoning abilities and final answer accuracy.

Another object of the present disclosure is to provide a method for controlling an artificial intelligence (AI) device that can include receiving a query, obtaining a plurality of ancillary opinions generated by a plurality of ancillary language models in response to the query, in which each of the plurality of ancillary opinions includes a chain-of-thought reasoning path derived by a corresponding one of the plurality of ancillary language models and an answer to the query, constructing an aggregated input sequence including the query and the plurality of ancillary opinions, and generating, by a fine-tuned main large language model, a final response based on the aggregated input sequence. Also, the fine-tuned main large language model is fine-tuned to synthesize the plurality of ancillary opinions to derive the final response.

It is another object of the present disclosure to provide a method, in which the fine-tuned main large language model is fine-tuned by a process includes receiving a training dataset including a plurality of training queries and a corresponding ground-truth answer for each of the plurality of training queries, generating, via the plurality of ancillary language models corresponding to a data curation phase, a plurality of training ancillary opinions for each of the plurality of training queries, in which each training ancillary opinion includes a reasoning path, generating augmented training samples for the plurality of training queries by combining a corresponding training query, a corresponding plurality of training ancillary opinions, and the corresponding ground-truth answer for each of the plurality of training queries, and fine-tuning a main large language model based on the augmented training samples to minimize a loss function to generate the fine-tuned main large language model.

Yet another object of the present disclosure is to provide a method, in which the fine-tuning the main large language model includes calculating the loss function on tokens corresponding to the ground-truth answer while masking tokens corresponding to the corresponding training query and the corresponding plurality of training ancillary opinions.

An object of the present disclosure is to provide a method, in which the constructing the aggregated input sequence includes arranging the plurality of ancillary opinions in a fixed order relative to the query, and the fixed order corresponds to an order used during fine-tuning of the fine-tuned main large language model.

Another object of the present disclosure is to provide a method, in which the constructing the aggregated input sequence includes inserting distinct delimiter tokens to demarcate a start and an end of the plurality of ancillary opinions within the aggregated input sequence.

An object of the present disclosure is to provide a method, in which the obtaining the plurality of ancillary opinions includes retrieving one or more few-shot examples from a training dataset, appending the one or more few-shot examples to the query to form a prompt, and transmitting the prompt to the plurality of ancillary language models to elicit the chain-of-thought reasoning path.

Yet another object of the present disclosure is to provide a method, in which the fine-tuned main large language model has a parameter count that is larger than a parameter count of at least one of the plurality of ancillary language models.

An object of the present disclosure is to provide a method, in which the plurality of ancillary opinions includes at least one opinion containing a correct reasoning path and at least one opinion containing an incorrect reasoning path, and the fine-tuned main large language model is configured to distinguish between the correct reasoning path and the incorrect reasoning path to generate the final response.

Another object of the present disclosure is to provide a method, in which the plurality of ancillary language models include a first ancillary model having a first model architecture and a second ancillary model having a second model architecture different from the first model architecture.

An object of the present disclosure is to provide a method, in which the obtaining the plurality of ancillary opinions includes executing the plurality of ancillary language models in parallel to simultaneously generate the plurality of ancillary opinions.

Another object of the present disclosure is to provide an artificial intelligence (AI) device including a memory configured to store information for a large language model, and a controller configured to receive a query, obtain a plurality of ancillary opinions generated by a plurality of ancillary language models in response to the query, in which each of the plurality of ancillary opinions includes a chain-of-thought reasoning path derived by a corresponding one of the plurality of ancillary language models and an answer to the query, construct an aggregated input sequence including the query and the plurality of ancillary opinions, and generate, by a fine-tuned main large language model, a final response based on the aggregated input sequence, in which the fine-tuned main large language model is fine-tuned to synthesize the plurality of ancillary opinions to derive the final response.

An object of the present disclosure is to provide a non-transitory computer readable medium storing computer-executable instructions that when executed by a processor, cause the processor to perform the operations of receiving a query, obtaining a plurality of ancillary opinions generated by a plurality of ancillary language models in response to the query, in which each of the plurality of ancillary opinions includes a chain-of-thought reasoning path derived by a corresponding one of the plurality of ancillary language models and an answer to the query, constructing an aggregated input sequence including the query and the plurality of ancillary opinions, and generating, by a fine-tuned main large language model, a final response based on the aggregated input sequence. Also, the fine-tuned main large language model is fine-tuned to synthesize the plurality of ancillary opinions to derive the final response.

In addition to the objects of the present disclosure as mentioned above, additional objects and features of the present disclosure will be clearly understood by those skilled in the art from the following description of the present disclosure.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 illustrates an AI device according to an embodiment of the present disclosure.

FIG. 2 illustrates an AI server according to an embodiment of the present disclosure.

FIG. 3 illustrates an AI device according to an embodiment of the present disclosure.

FIG. 4 illustrates an example encoder-decoder based transformer architecture for a large language model according to an embodiment of the present disclosure.

FIG. 5 illustrates an example flow chart for a method of controlling an AI device according to an embodiment of the present disclosure.

FIG. 6 illustrates an overview of a mixture of opinions (MoO) framework according to an embodiment of the present disclosure.

FIG. 7 illustrates an example data structure of an augmented training sample including a mixture of opinions according to an embodiment of the present disclosure.

### DETAILED DESCRIPTION OF THE EMBODIMENTS

Reference will now be made in detail to the embodiments of the present disclosure, examples of which are illustrated in the accompanying drawings.

Wherever possible, the same reference numbers will be used throughout the drawings to refer to the same or like parts.

Advantages and features of the present disclosure, and implementation methods thereof will be clarified through following embodiments described with reference to the accompanying drawings.

The present disclosure can, however, be embodied in different forms and should not be construed as limited to the embodiments set forth herein.

Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details.

Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present specification are used, another part can be added unless “only” is used. The terms of a singular form can include plural forms unless referred to the contrary.

In construing an element, the element is construed as including an error range although there is no explicit description. In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms.

These terms are only used to distinguish one element from another. For example, a first element could be termed a second element, and, similarly, a second element could be termed a first element, without departing from the scope of the present disclosure.

Further, “X-axis direction,” “Y-axis direction” and “Z-axis direction” should not be construed by a geometric relation only of a mutual vertical relation and can have broader directionality within the range that elements of the present disclosure can act functionally.

The term “at least one” should be understood as including any and all combinations of one or more of the associated listed items.

For example, the meaning of “at least one of a first item, a second item and a third item” denotes the combination of all items proposed from two or more of the first item, the second item and the third item as well as the first item, the second item or the third item.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship. Also, the term “can” used herein includes all meanings and definitions of the term “may.”

Hereinafter, the preferred embodiments of the present disclosure will be described in detail with reference to the accompanying drawings. All the components of each device or apparatus according to all embodiments of the present disclosure are operatively coupled and configured.

Artificial intelligence (AI) refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and can mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network can include an input layer, an output layer, and optionally one or more hidden layers. Each layer includes one or more neurons, and the artificial neural network can include a synapse that links neurons to neurons. In the artificial neural network, each neuron can output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network can be to determine the model parameters that minimize a loss function. The loss function can be used as an index to determine optimal model parameters in the learning process of the artificial neural network.

Machine learning can be classified into supervised learning, unsupervised learning, and reinforcement learning according to a learning method.

The supervised learning can refer to a method of learning an artificial neural network in a state in which a label for learning data is given, and the label can mean the correct answer (or result value) that the artificial neural network must infer when the learning data is input to the artificial neural network. The unsupervised learning can refer to a method of learning an artificial neural network in a state in which a label for learning data is not given. The reinforcement learning can refer to a learning method in which an agent defined in a certain environment learns to select a behavior or a behavior sequence that maximizes cumulative compensation in each state.

Machine learning, which can be implemented as a deep neural network (DNN) including a plurality of hidden layers among artificial neural networks, is also referred to as deep learning, and the deep learning is part of machine learning. In the following, machine learning is used to mean deep learning.

Self-driving refers to a technique of driving for oneself, and a self-driving vehicle refers to a vehicle that travels without an operation of a user or with a minimum operation of a user. For example, the self-driving can include a technology for maintaining a lane while driving, a technology for automatically adjusting a speed, such as adaptive cruise control, a technique for automatically traveling along a predetermined route, and a technology for automatically setting and traveling a route when a destination is set.

The vehicle can include a vehicle having only an internal combustion engine, a hybrid vehicle having an internal combustion engine and an electric motor together, and an electric vehicle having only an electric motor, and can include not only an automobile but also a train, a motorcycle, and the like.

At this time, the self-driving vehicle can be regarded as a robot having a self-driving function.

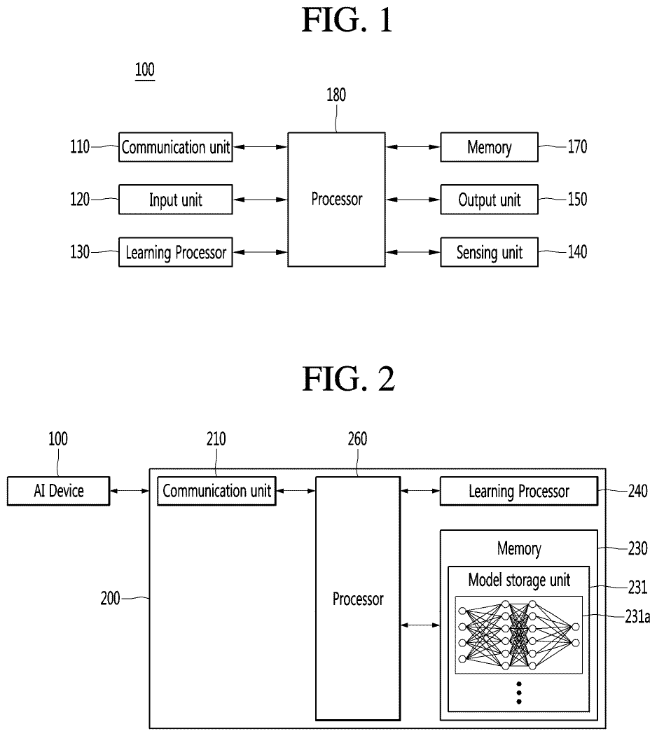

FIG. 1 illustrates an artificial intelligence (AI) device 100 according to one embodiment.

The AI device 100 can be implemented by a stationary device or a mobile device, such as a television (TV), a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like. However, other variations are possible.

Referring to FIG. 1, the AI device 100 can include a communication unit 110 (e.g., transceiver), an input unit 120 (e.g., touchscreen, keyboard, mouse, microphone, etc.), a learning processor 130, a sensing unit 140 (e.g., one or more sensors or one or more cameras), an output unit 150 (e.g., a display or speaker), a memory 170, and a processor 180 (e.g., a controller).

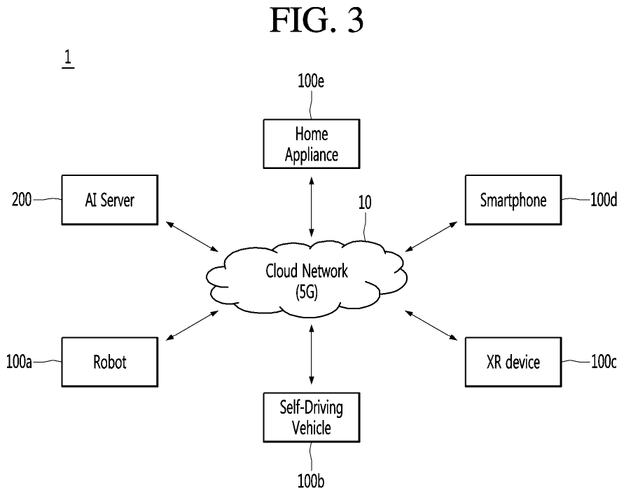

The communication unit 110 (e.g., communication interface or transceiver) can transmit and receive data to and from external devices such as other AI devices 100a to 100e and the AI server 200 (e.g., FIGS. 2 and 3) by using wire/wireless communication technology. For example, the communication unit 110 can transmit and receive sensor information, a user input, a learning model, and a control signal to and from external devices.

The communication technology used by the communication unit 110 can include GSM (Global System for Mobile communication), CDMA (Code Division Multi Access), LTE (Long Term Evolution), 5G, WLAN (Wireless LAN), Wi-Fi (Wireless-Fidelity), BLUETOOTH, RFID (Radio Frequency Identification), Infrared Data Association (IrDA), ZIGBEE, NFC (Near Field Communication), and the like.

The input unit 120 can acquire various kinds of data.

At this time, the input unit 120 can include a camera for inputting a video signal, a microphone for receiving an audio signal, and a user input unit for receiving information from a user. The camera or the microphone can be treated as a sensor, and the signal acquired from the camera or the microphone can be referred to as sensing data or sensor information.

The input unit 120 can acquire learning data for model learning and input data to be used when an output is acquired by using a learning model. The input unit 120 can acquire raw input data. In this situation, the processor 180 or the learning processor 130 can extract an input feature by preprocessing the input data.

The learning processor 130 can learn a model composed of an artificial neural network by using learning data. The learned artificial neural network can be referred to as a learning model. The learning model can be used to infer a result value for new input data rather than learning data, and the inferred value can be used as a basis for determination to perform a certain operation.

For example, the learning processor 130 can perform AI processing together with the learning processor 240 of the AI server 200.

Also, the learning processor 130 can include a memory integrated or implemented in the AI device 100. Alternatively, the learning processor 130 can be implemented by using the memory 170, an external memory directly connected to the AI device 100, or a memory held in an external device.

The sensing unit 140 can acquire at least one of internal information about the AI device 100, ambient environment information about the AI device 100, and user information by using various sensors.

Examples of the sensors included in the sensing unit 140 can include a proximity sensor, an illuminance sensor, an acceleration sensor, a magnetic sensor, a gyro sensor, an inertial sensor, an RGB sensor, an IR (infrared) sensor, a fingerprint recognition sensor, an ultrasonic sensor, an optical sensor, a camera, a microphone, a lidar, and a radar.

The output unit 150 can generate an output related to a visual sense, an auditory sense, or a haptic sense.

Also, the output unit 150 can include a display unit for outputting time information, a speaker for outputting auditory information, and a haptic module for outputting haptic information.

The memory 170 can store data that supports various functions of the AI device 100. For example, the memory 170 can store input data acquired by the input unit 120, learning data, a learning model, a learning history, and the like.

The processor 180 can determine at least one executable operation of the AI device 100 based on information determined or generated by using a machine learning algorithm. The processor 180 can control the components of the AI device 100 to execute the determined operation. For example, the processor 180 can implement an AI model to generate output based on a plurality of modalities. Also, the generated output can be used by AI systems in various downstream related tasks other than text generate (e.g., object identification, control instructions to move a robot, control maneuvering for a self-driving vehicle, in game content generation, etc.).

To this end, the processor 180 can request, search, receive, or utilize data of the learning processor 130 or the memory 170. The processor 180 can control the components of the AI device 100 to execute the predicted operation or the operation determined to be desirable among the at least one executable operation.

When the connection of an external device is used to perform the determined operation, the processor 180 can generate a control signal for controlling the external device and can transmit the generated control signal to the external device.

Also, the system can include the AI device 100 comprising a controller or processor 180 and a memory 170 storing instructions and databases (such as the MOO dataset). The processor 180 can be configured to execute the various modules described herein, such as the ancillary model manager, the sequence constructor, and the main LLM inference engine. The Ai device 100 can communicate with external clients or remote ancillary models via a network interface 110 (e.g., communication unit).

The processor 180 can acquire information from the user input and produce an answer to a query, carry out an action or movement, animate a displayed avatar or a recommend an item or action.

The processor 180 can acquire the information corresponding to the user input by using at least one of a speech to text (STT) engine for converting speech input into a text string or a natural language processing (NLP) engine for acquiring intention information of a natural language.

At least one of the STT engine or the NLP engine can be configured as an artificial neural network, at least part of which is learned according to the machine learning algorithm. At least one of the STT engine or the NLP engine can be learned by the learning processor 130, can be learned by the learning processor 240 of the AI server 200 (see FIG. 2), or can be learned by their distributed processing.

The processor 180 can collect history information including user profile information, the operation contents of the AI device 100 or the user's feedback on the operation and can store the collected history information in the memory 170 or the learning processor 130 or transmit the collected history information to the external device such as the AI server 200. The collected history information can be used to update the learning model.

The processor 180 can control at least part of the components of AI device 100 to drive an application program stored in memory 170. Furthermore, the processor 180 can operate two or more of the components included in the AI device 100 in combination to drive the application program.

FIG. 2 illustrates an AI server according to one embodiment.

Referring to FIG. 2, the AI server 200 can refer to a device that learns an artificial neural network by using a machine learning algorithm or uses a learned artificial neural network. The AI server 200 can include a plurality of servers to perform distributed processing, or can be defined as a 5G network, 6G network or other communications network. Also, the AI server 200 can be included as a partial configuration of the AI device 100, and can perform at least part of the AI processing together.

The AI server 200 can include a communication unit 210, a memory 230, a learning processor 240, a processor 260, and the like.

The communication unit 210 can transmit and receive data to and from an external device such as the AI device 100.

The memory 230 can include a model storage unit 231. The model storage unit 231 can store a learning or learned model (or an artificial neural network 231a) through the learning processor 240.

The learning processor 240 can learn the artificial neural network 231a by using the learning data. The learning model can be used in a state of being mounted on the AI server 200 of the artificial neural network, or can be used in a state of being mounted on an external device such as the AI device 100.

The AI model can be implemented in hardware, software, or a combination of hardware and software. If all or part of the learning models are implemented in software, one or more instructions that constitute the learning model can be stored in the memory 230.

The processor 260 can infer the result value for new input data by using the AI model and can generate a response or a control command based on the inferred result value.

FIG. 3 illustrates an AI system 1 including a terminal device according to one embodiment.

Referring to FIG. 3, in the AI system 1, at least one of an AI server 200, a robot 100a, a self-driving vehicle 100b, an XR (extended reality) device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, can be referred to as AI devices 100a to 100e. The AI server 200 of FIG. 3 can have the configuration of the AI server 200 of FIG. 2.

According to an embodiment, the method can be implemented as an interactive application or program that can be downloaded or installed in the smartphone 100d, which can communicate with the AI server 200, but embodiments are not limited thereto.

The cloud network 10 can refer to a network that forms part of a cloud computing infrastructure or exists in a cloud computing infrastructure. The cloud network 10 can be configured by using a 3G network, a 4G or LTE network, a 5G network, a 6G network, or other network.

For instance, the devices 100a to 100e and 200 configuring the AI system 1 can be connected to each other through the cloud network 10. In particular, each of the devices 100a to 100e and 200 can communicate with each other through a base station, but can directly communicate with each other without using a base station.

The AI server 200 can include a server that performs AI processing and a server that performs operations on big data. According to embodiments, the AI model can be fully implemented on an edge device (e.g., locally on devices 100a to 100e) or fully implemented AI server 200 in which an edge device collected the raw audio and video signals to provide to the AI server 200. According to another embodiment, parts of the AI model can be distributed across both of an edge device and the AI server 200.

The AI server 200 can be connected to at least one of the AI devices constituting the AI system 1, that is, the robot 100a, the self-driving vehicle 100b, the XR device 100c, the smartphone 100d, or the home appliance 100e through the cloud network 10, and can assist at least part of AI processing of the connected AI devices 100a to 100e.

In addition, the AI server 200 can learn the artificial neural network according to the machine learning algorithm instead of the AI devices 100a to 100e, and can directly store the learning model or transmit the AI model to the AI devices 100a to 100e.

Further, the AI server 200 can receive input data from the AI devices 100a to 100e, can infer the result value for the received input data by using the AI model, can generate a response or a control command based on the inferred result value, and can transmit the response or the control command to the AI devices 100a to 100e. Each AI device 100a to 100e can have the configuration of the AI device 100 of FIGS. 1 and 2 or other suitable configurations.

Alternatively, the AI devices 100a to 100e can infer the result value for the input data by directly using the learning model, and can generate the response or the control command based on the inference result.

Hereinafter, various embodiments of the AI devices 100a to 100e to which the above-described technology is applied will be described. The AI devices 100a to 100e illustrated in FIG. 3 can be regarded as a specific embodiment of the AI device 100 illustrated in FIG. 1.

According to an embodiment, the home appliance 100e can be a smart television (TV), smart microwave, smart oven, smart washing machine or dryer, smart refrigerator or other display device, which can implement one or more of a large language model (LLM), a chat-bot, a digital avatar assistant, an online shopping assistant or concierge, a question and answering system or a recommendation system, etc. The method can be in the form of an executable application or program.

The robot 100a, to which the AI technology is applied, can be implemented as an entertainment robot, a guide robot, a carrying robot, a cleaning robot, a wearable robot, a pet robot, an unmanned flying robot, a home robot, a care robot or the like.

The robot 100a can include a robot control module for controlling the operation, and the robot control module can refer to a software module or a chip implementing the software module by hardware.

The robot 100a can acquire state information about the robot 100a by using sensor information acquired from various kinds of sensors, can detect (recognize) surrounding environment and objects, can generate map data, can determine the route and the travel plan, can determine the response to user interaction, or can determine the operation.

The robot 100a can use the sensor information acquired from at least one sensor among the lidar, the radar, and the camera to determine the travel route and the travel plan.

The robot 100a can perform the above-described operations by using the AI model composed of at least one artificial neural network. For example, the robot 100a can recognize the surrounding environment and the objects by using the AI model, and can determine the operation by using the recognized surrounding information or object information. The learning model can be learned directly from the robot 100a or can be learned from an external device such as the AI server 200.

At this time, the robot 100a can perform the operation by generating the result by directly using the AI model, but the sensor information can be transmitted to the external device such as the AI server 200 and the generated result can be received to perform the operation.

The robot 100a can use at least one of the map data, the object information detected from the sensor information, or the object information acquired from the external apparatus to determine the travel route and the travel plan, and can control the driving unit such that the robot 100a travels along the determined travel route and travel plan. Further, the robot 100a can determine an action to pursue, generate an output or an item to recommend. Also, the robot 100a can generate an answer in response to a user query and the robot 100a can have animated facial expressions. The answer can be in the form of natural language.

The map data can include object identification information about various objects arranged in the space in which the robot 100a moves. For example, the map data can include object identification information about fixed objects such as walls and doors and movable objects such as desks. The object identification information can include a name, a type, a distance, and a position.

In addition, the robot 100a can perform the operation or travel by controlling the driving unit based on the control/interaction of the user. Also, the robot 100a can acquire the intention information of the interaction due to the user's operation or speech utterance, and can determine the response based on the acquired intention information, and can perform the operation while providing an animated face.

The robot 100a, to which the AI technology and the self-driving technology are applied, can be implemented as a guide robot, a carrying robot, a cleaning robot (e.g., an automated vacuum cleaner), a wearable robot, an entertainment robot, a pet robot, an unmanned flying robot (e.g., a drone or quadcopter), or the like.

The robot 100a, to which the AI technology and the self-driving technology are applied, can refer to the robot itself having the self-driving function or the robot 100a interacting with the self-driving vehicle 100b.

The robot 100a having the self-driving function can collectively refer to a device that moves for itself along the given movement line without the user's control or moves for itself by determining the movement line by itself.

The robot 100a and the self-driving vehicle 100b having the self-driving function can use a common sensing method to determine at least one of the travel route or the travel plan. For example, the robot 100a and the self-driving vehicle 100b having the self-driving function can determine at least one of the travel route or the travel plan by using the information sensed through the lidar, the radar, and the camera.

The robot 100a that interacts with the self-driving vehicle 100b exists separately from the self-driving vehicle 100b and can perform operations interworking with the self-driving function of the self-driving vehicle 100b or interworking with the user who rides on the self-driving vehicle 100b.

In addition, the robot 100a interacting with the self-driving vehicle 100b can control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b can monitor the user boarding the self-driving vehicle 100b and the user's emotional state, or can control the function of the self-driving vehicle 100b through the interaction with the user. For example, when it is determined that the driver is in a drowsy state or an angry state, the robot 100a can activate the self-driving function of the self-driving vehicle 100b or assist the control of the driving unit of the self-driving vehicle 100b. The function of the self-driving vehicle 100b controlled by the robot 100a can include not only the self-driving function but also the function provided by the navigation system or the audio system provided in the self-driving vehicle 100b.

Also, the robot 100a that interacts with the self-driving vehicle 100b can provide information or assist the function to the self-driving vehicle 100b outside the self-driving vehicle 100b. For example, the robot 100a can provide traffic information including signal information and the like, such as a smart signal, to the self-driving vehicle 100b, and automatically connect an electric charger to a charging port by interacting with the self-driving vehicle 100b like an automatic electric charger of an electric vehicle. Also, the robot 100a can provide information and services to the user via a digital avatar, which can be personally tailored to the user based on the user's personal preferences.

According to an embodiment, the AI device 100 can provide a method for enhancing the logical reasoning of a primary large language model (LLM) by fine-tuning the primary LLM on a training dataset augmented with a plurality of opinions generated by one or more ancillary LLMs to produce a final answer with improved accuracy and logical consistency.

According to another embodiment, the AI device 100 can be integrated into an infotainment system of the self-driving vehicle 100b, which can recognize different users and their emotional states, and recommend content, provide personalized services or provide answers based on various input modalities, the content can include one or more of audio recordings, video, music, pod casts, etc., but embodiments are not limited thereto. Also, the AI device 100 can be integrated into an infotainment system of the manual or human-driving vehicle.

As discussed above, embodiments of the present disclosure relate to the field of artificial intelligence (AI) and machine learning, and more particularly, to methods and systems for enhancing the reasoning capabilities of large language models (LLMs) to improve their performance on complex problem-solving tasks.

For example, embodiments of the present disclosure can provide for a framework for enhancing the reasoning capabilities of large language models, which can be viewed as a foundational component for applications requiring complex problem solving and logical analysis, such as in the fields of financial modeling, scientific research, software code generation and debugging, and advanced data analytics.

As discussed above, the reasoning capabilities of large language models (LLMs) face several challenges that limit their reliability and practical utility, particularly in domains requiring precise, multi-step logical deduction such as mathematics and science. While these models have become proficient at language centric tasks, their performance in complex problem solving depends on constructing a coherent and accurate chain of reasoning to arrive at a correct answer.

One significant challenge is the potential unreliability of a single model's reasoning process. When attempting to solve a complex problem, an LLM may generate a sequence of logical steps that appears plausible but could contain a subtle flaw. For example, in solving a multi-step algebraic equation, the model may correctly execute the first few steps but make a single arithmetic error or misapply a theorem in the middle of the process. This single point of failure can invalidate the entire solution, yet the model may still present the erroneous result with a high degree of confidence. This reliance on a single reasoning path makes existing models prone to unpredictable and often undetectable errors.

Another example of this limitation is evident in existing approaches to supervised fine-tuning (SFT) for improving LLM performance. In a typical SFT process, a model is trained on a dataset containing problems and a single corresponding ground truth solution path. This approach can inadvertently teach the model to memorize specific solution patterns rather than developing robust, generalizable reasoning skills. For example, it may fail to expose the model to alternative lines of reasoning or teach it how to identify and recover from incorrect assumptions. The resulting model may face overfitting issues in which it performs well on problems similar to its training data but lacks the flexibility to reason through novel or nuanced challenges.

A further challenge is the reliance on scaling up the size of the model as the primary means of improving reasoning performance. It has been observed that significant gains in logical reasoning capabilities often require exponentially larger models and vast computational resources for training. This approach often yields diminishing returns and can be economically and technically prohibitive for many users and applications. Accordingly, a need exists for an improved device and method that can enhance the reasoning capabilities of LLMs in a more robust and cost effective manner, without exclusively relying on increases in model size.

According to an embodiment, the AI device 100 can provide an LLM-based reasoning enhancement framework that overcomes the limitations of prior approaches. For example, a multi-stage framework can be employed that utilizes a primary large language model (LLM) in coordination with a plurality of ancillary LLMs, in which different models contribute distinct reasoning perspectives. The framework can include a dataset curation component to generate a diverse set of ancillary opinions comprising chain-of-thought reasoning paths, a fine-tuning component to train the primary model to analyze and synthesize these opinions against a ground truth, and an inference component to generate a final answer for a new query based on the synthesized insights, thereby ensuring superior reasoning capability and higher accuracy compared to other approaches.

An LLM-based reasoning framework can offer many advantages. For example, Large Language Models (LLMs) can be utilized to implement the distinct roles of the primary solver and the ancillary opinion providers. These models can be configured to generate explicit chain-of-thought reasoning steps alongside their predicted answers, which can enable the framework to aggregate a rich diversity of logical perspectives and allows the primary model to discern optimal reasoning paths from the collective input to solve complex problems with greater reliability.

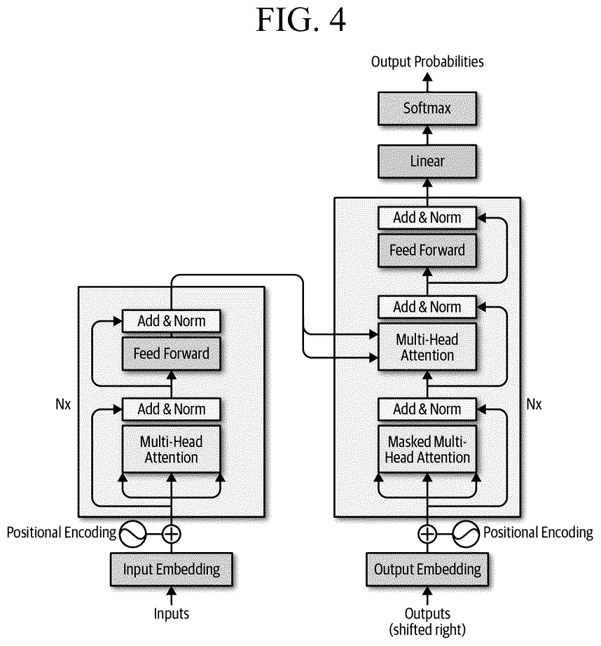

FIG. 4 illustrates an example encoder-decoder based transformer architecture for a large language model according to an embodiment of the present disclosure. For example, the method can leverage one or more large language models (LLMs). According to an embodiment, the LLM can be based on an encoder-decoder architecture, which employs self-attention mechanisms.

Further, these attention mechanisms can allow the model to weigh the importance of different parts of an input sequence (e.g., words in a sentence or sentences in a document) when processing information to allow the model to capture long-range dependencies and contextual relationships effectively, which is particularly relevant for understanding complex user queries or detailed product descriptions.

According to an embodiment, each LLM can undergo its own pre-training phase, in which the LLM is trained on a massive and diverse amount of text and code. During this unsupervised or self-supervised learning stage, the model can learn fundamental language patterns, grammatical structures, factual knowledge, and even reasoning capabilities (e.g., predicting masked words or the next sequence of text).

According to an embodiment, the LLM portions (e.g., the main LLM model and the ancillary LLM models) can be subject to a fine-tuning phase. Fine-tuning can involve further training the pre-trained model on smaller, more specialized datasets tailored to specific tasks (e.g., question answering, summarization, specific domain knowledge) or to align the model's behavior with desired characteristics, such as improved instruction following or safety protocols. According to embodiments, the AI model can advantageously utilize pre-trained LLMs, potentially without requiring extensive task-specific fine-tuning for its core agent functionalities. For example, according to an embodiment, the AI model can be LLM agnostic, but embodiments are not limited thereto.

For example, the LLM portion can operate by processing textual inputs (e.g., prompts) which can include questions, instructions, or other text intended to elicit a specific response. The LLM can leverage its learned knowledge to generate a corresponding textual output, such as an answer, a summary, or other contextually relevant content. Also, according to an embodiment, the LLM portion can be multi-modal to accept and operate on other types of input, such as images, video, etc.

In addition, one or more of the various components of the framework, such as the plurality of ancillary language models or the main language model, can be configured or extended as artificial intelligence agents. For example, an AI agent can be an autonomous computational system designed to process a query and generate a specific reasoning output to achieve a solution.

An agent can receive inputs, such as a math or logic problem, perform reasoning about those inputs based on its internal parameters, and produce a structured opinion or execute tasks in response. According to embodiments, these agents can range from specialized, smaller models to highly complex proprietary models capable of sophisticated reasoning and decision-making.

According to an embodiment, the one or more AI agents can be based on Large Language Models (LLMs) that can be endowed with more sophisticated capabilities, such as chain-of-thought planning, context retention, and the ability to use external tools.

For example, a planning module can allow an ancillary agent to decompose a high-level query into a sequence of smaller, manageable reasoning steps (e.g., a chain-of-thought path) to derive an answer. A memory module can provide the main agent with the ability to retain information from the aggregated sequence of multiple ancillary opinions, allowing it to maintain context across diverse perspectives and learn to distinguish correct logic from incorrect logic over time.

Further, the ability to use external tools can enable the agents to interact with other software, APIs, or data source (e.g., such as computational engines or knowledge bases) to gather verification data or perform intermediate calculations to execute a wide variety of complex, real-world mathematical or logical tasks.

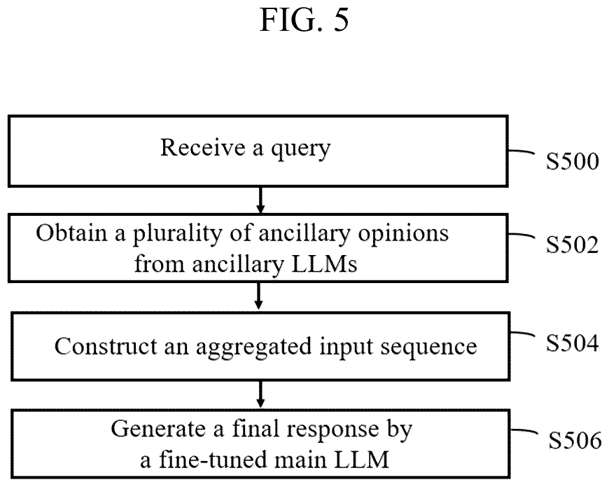

FIG. 5 shows an example flow chart of a method for controlling an AI device according to an embodiment of the present disclosure. For example, the method can include receiving, by a processor in the AI device 100, a query (e.g., S500). The method further includes obtaining a plurality of ancillary opinions generated by a plurality of ancillary language models in response to the query (e.g., S502). According to an embodiment, each of the plurality of ancillary opinions includes not only a predicted answer to the query but also a chain-of-thought reasoning path derived by the corresponding ancillary language model.

The method further continues by constructing an aggregated input sequence including the query and the plurality of ancillary opinions (e.g., S504), and generating, by a fine-tuned main large language model, a final response based on the aggregated input sequence (e.g., S506). Also, the main language model is fine-tuned to synthesize the plurality of ancillary opinions to derive the final response.

According to an embodiment, the fine-tuned main large language model utilized in step S506 is fine-tuned by a specific process. This specific process can include receiving a training dataset including a plurality of training queries and a corresponding ground-truth answer for each query. The process further involves generating, via the plurality of ancillary language models (corresponding to a data curation phase), a plurality of training ancillary opinions for each training query, where each opinion includes a reasoning path. These components are then combined to generate augmented training samples, which are used to fine-tune the main model to minimize a loss function.

In more detail, according to an embodiment, the fine-tuning process includes calculating the loss function selectively. For example, the loss function can be calculated on tokens corresponding to the ground-truth answer, while masking tokens corresponding to the training query and the plurality of training ancillary opinions. This masking technique can ensure that the model is trained to reason based on the provided opinions without being penalized for the content of the opinions themselves.

Having described the general system and method steps, the following discussion focuses on the specific implementation of the Mixture of Opinions (MoO) framework, detailing the data flow through the curation, training, and inference stages, according to embodiments.

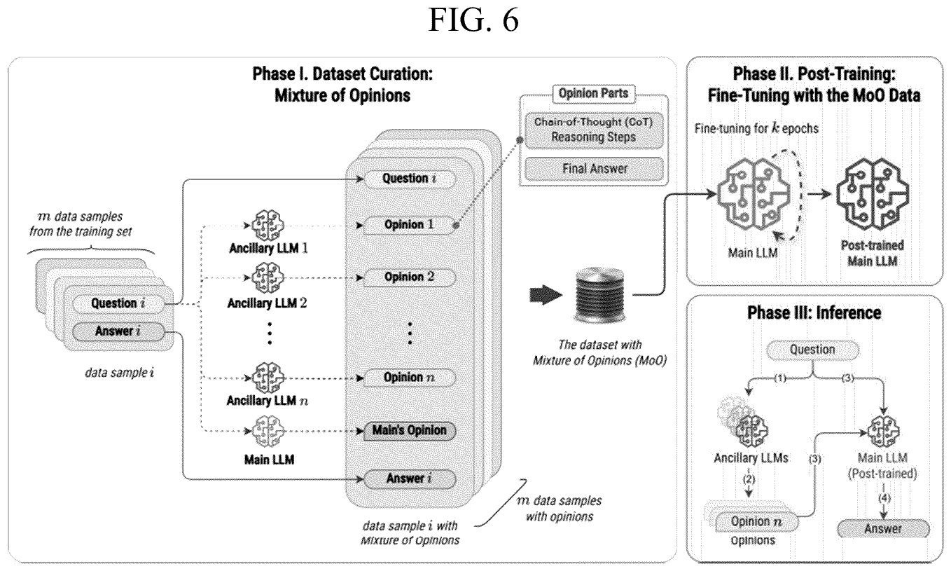

FIG. 6 is a flowchart illustrating an example of the mixture of opinions (MoO) framework, according to an embodiment of the present disclosure. For example, according to an embodiment, the AI model can be implemented as a cohesive architecture of interconnected modules.

For example, as shown in FIG. 6, the MOO framework can include three distinct phases, such as a dataset curation/augmentation phase (e.g., Phase I), a fine-tuning (post-training) phase (e.g., Phase II), and an inference phase (e.g., Phase III), according to an embodiment. This multi-phase approach is designed to systematically enhance the reasoning capabilities of a main language model by leveraging the collective intelligence of multiple ancillary models. By integrating diverse reasoning paths before the final generation step, the framework can transform the main model from a solitary solver into a synthesizer of different logical perspectives.

In the first phase (e.g., Phase I), a dataset curation or data augmentation stage, the system can process a standard training dataset containing query-answer pairs. Instead of relying solely on the ground-truth answers, the system can query a plurality of ancillary language models to generate “opinions” for each training sample.

For example, these opinions are not merely final answers, they can include the explicit chain-of-thought (CoT) reasoning steps used by each ancillary model to reach its conclusion. These ancillary opinions can then be embedded into the training data to create an augmented dataset where each sample can include the original query, a block of diverse reasoning paths and ancillary answers (e.g., opinions), and the final ground-truth solution.

In other words, the output of Phase I is an augmented training dataset where each entry combines the original query with the plurality of generated ancillary opinions and the corresponding ground-truth answer.

In the second phase (e.g., Phase II), a fine-tuning or post-training stage, the main language model can be trained using the curated/augmented MoO dataset. Unlike standard supervised fine-tuning that maps a query directly to an answer, this phase can train the main model to process the aggregated input sequence (e.g., which can include the diverse and potentially conflicting opinions from the ancillary models) to derive the correct ground-truth answer. Through this process, the main model can learn to analyze various logical approaches, identify errors in incorrect opinions, and synthesize valid reasoning steps to construct a robust final answer.

Accordingly, the output of Phase II is the fine-tuned main language model, which is configured to analyze the plurality of ancillary opinions and synthesize their reasoning steps to determine the correct solution.

In the third phase (e.g., Phase III), an inference stage, the fine-tuned main model can be deployed to handle new, unseen user queries. For example, when a query is received, the system can send the query to the available ancillary models to generate fresh opinions in real-time.

Then, these opinions can be aggregated with the user query to form a prompt that is similar in structure to the training data. The fine-tuned main model can then process this prompt which provides enriched context to generate a high quality final response.

This inference process can allow the model to effectively consult with the ancillary experts dynamically, which can significantly improve accuracy on complex mathematical or logical tasks compared to the model operating in isolation. In other words, the final model can be trained on different points of view (e.g., during SFT) while also being configured to leverage a fresh collection of diverse opinions to reason through and resolve novel situations during the inference stage.

For example, the output of phase III is a final response to a new query, generated by the fine-tuned main model based on the synthesis of real-time opinions from the ancillary models.

In this way, the MOO framework can be viewed as being similar to a human learning process where an individual observes the trial and error reasoning of peers to distinguish valid logic from flaws, effectively allowing the model to bring that learned experience into a type of committee of experts environment where it acts as the leader of such a committee to synthesize diverse perspectives to resolve novel problems.

In more detail, the left portion of FIG. 6 is a schematic diagram illustrating the detailed components and data flow of the Phase I dataset curation/augmentation pipeline, according to an embodiment of the present disclosure.

As shown, the process can begin with the receipt of a seed training dataset. This dataset can serve as a foundational input and can include a plurality of standard training samples (e.g., thousands or millions of samples), where each sample can include a source query (e.g., a math problem, user question, or logical riddle) and a corresponding ground-truth answer. The goal of this phase is to amplify this initial input into a comprehensive “Mixture of Opinions” (MoO) dataset that enriches the ground truth with diverse reasoning perspectives.

Further in this example, the source queries from the seed dataset can be processed by an ancillary model manager module or registry. According to an embodiment, the registry can be a database or a software interface configured to store or access a plurality of ancillary language models.

These ancillary large language models can be distinct from one another in terms of architecture, parameter size, or training background. For example, the plurality of ancillary models can include models such as LLaMA, Mistral, and Gemma. However, embodiments are not limited thereto, and other types of open-source or proprietary models can be used as ancillary agents.

According to an embodiment, the ancillary model manager can be configured to select a specific subset of models for each query, or it may utilize all available models. For example, for a complex calculus query, the ancillary model manager might prioritize models known for mathematical proficiency, whereas for a logic puzzle, it might select a broader range of generalist models. However, embodiments are not limited thereto, and a same group ancillary models can be used for each data sample when generating the augmented dataset with the mixture of opinions (MoO).

According to embodiments, the ancillary models can be sorted or ranked based on various criteria or characteristics.

For example, according to an embodiment, the framework can be initialized with a pool of candidate Large Language Models (LLMs) (e.g., L₁ . . . Lₙ₊₁). In this example, the models can be ranked according to their original performance on a specific task (e.g., mathematical reasoning benchmarks, etc.), such that Lₙ₊₁>Lₙ> . . . >Lᵢ> . . . >L₂>L₁. In this hierarchy, each subsequent model Lᵢ+1 can represent a model with higher capability (e.g., accuracy or parameter count) than the preceding model Lᵢ.

Within the MoO framework, the highest-performing model, Lₙ₊₁, is designated as the “main” or “primary” LLM. Conversely, the remaining models are designated as “ancillary” LLMs. The specific role of these ancillary models is to generate auxiliary and diverse opinions that serve as context to enhance the overall reasoning performance of the main LLM.

Notably, while the ancillary LLMs are characterized in this embodiment as being “weaker” than the main LLM, they are selected based on their possession of comparable reasoning abilities and their capacity to consistently generate well-structured, coherent responses (e.g., Chain-of-Thought outputs) that contribute valuable diversity to the aggregated input.

According to an embodiment, the framework can execute a MoO dataset curation phase to prepare the data for fine-tuning. In this step, the system can collect diverse perspectives by prompting the set of ancillary LLMs to generate responses (e.g., opinions) for a given training query. To facilitate high quality outputs, the prompt provided to the ancillary models can optionally include one shot or few-shot examples drawn from the training set. The resulting opinions generated by the ancillary models include both the Chain-of-Thought (CoT) reasoning steps and the predicted final answers.

The system then constructs the augmented training samples by inserting the collected opinions between the original question and the verified ground-truth answer (e.g., which is also CoT-formatted).

Consequently, the final curated MoO dataset contains training examples augmented with a “committee” of reasoning paths. Also, in this example embodiment, the opinions from the ancillary LLMs are aggregated in a fixed, predetermined order (e.g., Opinion from Model A, followed by Opinion from Model B, etc.). This fixed ordering can be strictly maintained to guarantee structural consistency between the pattern learned during the fine-tuning phase and the input sequence structure used during the subsequent inference phase.

For example, according to an embodiment, a parallel generation module (e.g., opinion generator) can transmit the source query to the selected plurality of ancillary language models. Each ancillary model can receive the query and is prompted to generate an ancillary opinion. For example, the system prompts these models not just for a final answer, but also for a Chain-of-Thought (CoT) response. This means that each model outputs a text sequence containing the intermediate reasoning steps it took to arrive at its conclusion.

Then, the generation engine can output a set of ancillary opinions corresponding to the single source query. It is noted that because these ancillary models may be weaker or smaller than the primary model eventually being trained, the set of opinions may contain a mix of correct reasoning, partially correct reasoning, and incorrect reasoning or hallucinations. According to an embodiment, this diversity can be a feature and not a bug, in order to show the main LLM what to do and how to act, but also to show the main LLM what not to do. For example, similar to how a human can learn from the mistakes and successes of others.

This opinion data can then be fed into a sequence constructor module or data formatter (e.g., aggregator). The sequence constructor can combine the various components into a single, cohesive training object. For example, according to an embodiment, the sequence constructor module can generate an aggregated input sequence by concatenating the original source query with the generated plurality of ancillary opinions. Also, as noted above, each ancillary opinion can include that model's chain of though reasoning and its final answer.

According to an embodiment, the sequence constructor can insert special delimiter tokens to structure the data for the model. For example, it may insert <start_opinion> and <end_opinion> tokens or special character sequences around each ancillary output to clearly indicate where one model's perspective ends and another begins.

Then, the sequence constructor can combine this aggregated input sequence with the original ground-truth answer (e.g., from the seed dataset) to form a final MoO training sample. This process is repeated for the plurality of samples in the seed dataset, resulting in the output of a fully curated MoO Dataset. For example, this augments dataset is now enriched with both the problem, the diverse attempts to solve it (e.g., the opinions), and the verified solution, and is stored in a memory database and ready to be used as training data for the subsequent fine-tuning stage.

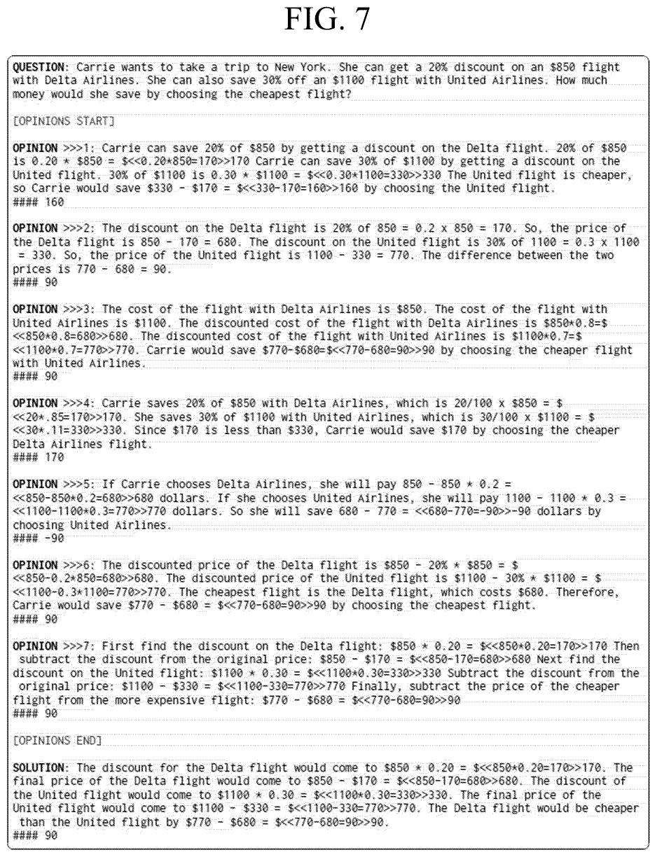

FIG. 7 illustrates an example data structure of an augmented training sample including a mixture of opinions which can be used to train the main language model, according to an embodiment of the present disclosure. Also, the prompt can further include instructions to think step by step and to show their reasoning.

According to an embodiment, the data structure can be organized linearly to simulate a context in which the model is presented with a problem and a committee of advice before being tasked with determining the correct solution.

As shown in the example in FIG. 7, the sequence includes a query. In this specific working example, the query presents a math word problem of “Carrie wants to take a trip to New York. She can get a 20% discount on an $850 flight with Delta Airlines. She can also save 30% off an $1100 flight with United Airlines. How much money would she save by choosing the cheapest flight?” This component serves as the anchor or prompt, providing the raw facts (e.g., prices and discount rates) that both the ancillary models and the main model are to process.

Following the query, the structure includes a delimited opinions block. This block is bounded by special tokens, such as [OPINIONS START] and [OPINIONS END], which function as signal markers to the main model indicating that the text contained therein represents external, potentially unreliable “advice” rather than objective fact.

Within this delimited opinions block, a plurality of distinct ancillary opinions are aggregated, each identified by a header (e.g., OPINION>>>1, OPINION>>>2, etc.). Also, each model's answer can be marked with four pound signs (e.g., ####). However, embodiments are not limited thereto, and other types of delineation characters or organization formatting can be used.

The contents of the opinions block demonstrate a feature of the MoO method regarding the diversity of reasoning paths. For instance, Opinion 1 performs a reasoning chain that calculates the discount amounts (e.g., $170 and $330) but incorrectly concludes that the United flight is cheaper and subtracts the discount amounts to reach a flawed answer of “160.” Similarly, Opinion 5 correctly sets up the price calculations but fails in the final subtraction, resulting in a nonsensical negative value of “−90.” Conversely, Opinion 2 and Opinion 6 demonstrate correct Chain-of-Thought (CoT) reasoning. They accurately calculate the final ticket prices (e.g., $680 for Delta, $770 for United), identify the Delta flight as the cheaper option and correctly determine the difference is $90.

For example, this mixture of valid logic (e.g., Opinions 2, 6, 7) and flawed logic (e.g., Opinions 1, 4, 5) creates a noisy training environment. By exposing the main model to this specific data structure during Phase II, the model is able to learn a discriminative capability. It does simply copy the first opinion it sees, rather the model learns to analyze the multiple reasoning paths, recognize that Opinion 1 contains a logical fallacy (e.g., comparing discounts rather than final prices) and that Opinion 5 contains an arithmetic error, and learn to attend to the robust reasoning patterns found in Opinions 2 and 6.

Then, the data structure concludes with the target solution, labeled here as SOLUTION. This contains the verified ground-truth reasoning and the final answer: “The Delta flight would be cheaper than the United flight by $770-$680=90.” During the supervised fine-tuning process, the model can use the query and the opinions block as input and can calculate a loss function based on its ability to generate this correct target solution. For example, this structure can effectively train the model to act as a synthesizer, filtering out the incorrect ancillary opinions to converge on the accurate solution.

In more detail, the upper right portion of FIG. 6 illustrates the detailed components and data flow of the Phase II fine-tuning pipeline, according to an embodiment of the present disclosure.

As shown, the fine tuning process can begin with the retrieval of the curated MoO dataset from storage. This dataset serves as the training corpus and can range in size from a few thousand to several million augmented samples. As described in the previous section, each sample in the curated MoO dataset can include a specific structured sequence, such as the original user query, a block of diverse ancillary opinions (e.g., containing both correct and incorrect reasoning paths), and the verifiable ground-truth solution. The goal of this stage is to condition the main language model to utilize these opinions as a type of intermediate scratchpad material to derive the correct answer.

Further in this example, the training process involves fine tuning a main large language model. According to an embodiment, this main LLM can be a transformer based architecture with a parameter count that is significantly larger than that of the ancillary models used in Phase I (e.g., a 14B or even 70B parameter model vs. 7B parameter ancillary models). However, embodiments are not limited thereto and the main LLM may have the same or fewer parameters as the ancillary models.

Further in this example, the main LLM can be loaded onto a training infrastructure, which can include one or more high performance graphics processing units (GPUs) or tensor processing units (TPUs) configured for parallel computation.

According to an embodiment, the process can proceed to a tokenization and embedding module. Here, the raw text of the MOO dataset can be converted into a sequence of numerical tokens. For example, the model is not trained to simply memorize the answer but is trained on the aggregated input sequence. The module can convert the query and the conflicting ancillary opinions into a context window (e.g., embedding vectors) that represents the state of the problem before the solution is generated.

In a forward pass step, the main LLM can process the tokenized input. Using internal self-attention mechanisms, the model can analyze the relationships between the query and the various reasoning steps provided in the ancillary opinions. The model then can generate a probability distribution for the next token in the sequence, e.g., attempting to predict the ground-truth solution step-by-step.

According to an embodiment, a loss calculation module can evaluate the performance of the model. The loss calculation module can utilize a specific loss function, such as cross-entropy loss, to quantify the difference between the model's predicted token or answer and the actual token from the ground-truth answer in the training sample.

Further, the loss calculation can be applied selectively. For example, a masking technique can be employed such that the loss is calculated only on the tokens corresponding to the ground-truth solution (e.g., the target output), while the tokens corresponding to the query and the ancillary opinions (e.g., the input context) are masked out. This can ensure that the model is penalized only for failing to generate the correct answer, while being conditioned on the presence of the noisy opinions. This can force the model to learn a synthesizing function for figuring out which parts of the ancillary opinions (e.g., Opinion 2 and 6 from the previous example) are useful for minimizing the loss, and which parts (e.g., Opinion 1) should be ignored.

Further in this example, a backpropagation and weight update module can utilize the calculated loss to adjust the internal parameters (e.g., weights) of the main LLM model. For example, an optimizer (e.g., such as AdamW or stochastic gradient descent SGD) updates the weights to minimize the loss over time. This iterative process can allow the model to learn to distinguish valid reasoning patterns from bad reasoning or hallucinations within the provided context.

According to an alternative embodiment, rather than updating all parameters of the main LLM model (e.g., full fine-tuning), the system can employ parameter-efficient fine-tuning (PEFT). For example, Low-Rank Adaptation (LoRA) adapters can be injected into the transformer layers. In this variation, only the small LoRA adapters are trained on the MOO dataset while the base model weights can remain frozen. This can allow for the efficient creation of a reasoning enhanced model without the massive computational overhead of retraining the entire network.

The output of Phase II is the fine-tuned main large language model. For example, this enhance model is now a specialized reasoning synthesizer. For example, the fine-tuned main LLM has been mathematically optimized to accept a query paired with a set of opinions and can extract a coherent, accurate logical path to the correct solution and is ready for deployment in the inference stage.

In more detail, the lower right portion of FIG. 6 illustrates the detailed components and data flow of the Phase III inference pipeline, according to an embodiment of the present disclosure. This phase represents the deployment or runtime stage where the system utilizes the trained capabilities to solve new problems.

As shown, the inference process can begin with the receipt of a question from a user or a client application. For example, this query can represent a novel input that the model has not necessarily seen before (e.g., a complex physics word problem or a piece of software code to be debugged, etc.). The goal of this stage is to generate a highly accurate final answer by leveraging the committee of opinions that the main model has been trained to synthesize.

Further in this example, query can be processed by an ancillary prompting module. According to an embodiment, to ensure the ancillary models provide high quality reasoning, the ancillary prompting module can retrieve a set of few-shot examples from the original training set. These examples can be prepended or appended to the user query to form a prompt context. The module then transmits this prompted query to the plurality of ancillary language models (e.g., L1 . . . Ln).

The ancillary models can then execute a generation step to produce a set of new opinions. For example, similar to the dataset curation phase, these ancillary models can be instructed to output chain-of-thought (CoT) reasoning steps alongside their final answers.

However, unlike the training phase where ground truth was known, here the system relies on the generative capabilities of the ancillary models in real-time. According to an embodiment, this step can be parallelized across multiple processing units or API endpoints to minimize latency, allowing all ancillary opinions to be gathered simultaneously.

Then, once the opinions are collected, a sequence assembler module can construct the final input for the main model. According to an embodiment, the sequence assembler can organize the new opinions in the exact same fixed order that as was used during the Phase II fine-tuning (e.g., if Model A was always Opinion 1 in training, it is also be Opinion 1 in inference). The sequence assembler can concatenate the user query, the ordered block of new opinions, and the requisite start/end tokens to form the aggregated inference sequence.

Further in this example, this aggregated inference sequence can then be fed into the fine-tuned main language model. Because the main LLM has been conditioned via the MoO framework, it can process the sequence as a deliberation context. For example, the main LLM can analyze the reasoning steps provided by the ancillary models, identify consensus or logical validity, and discard hallucinations or arithmetic errors found in the weaker models' opinions.

Further, the main large language model can generate the final response (e.g., the answer). This response can include the main model's own Chain-of-Thought reasoning followed by the final answer. For example, by effectively standing on the shoulders of the ancillary models, the main model is able to achieve a higher accuracy rate on the user query than it could have achieved acting in isolation, or than any of the ancillary models could have achieved individually.

According to an alternative embodiment, the system can be deployed in a distributed cloud environment. For example, the main large language model can be hosted on a primary high compute server (e.g., utilizing A100 GPUS), while the smaller ancillary models can be hosted on lower cost edge devices or CPU based servers. The distributed architecture can allow for cost effective scaling, e.g., the diverse opinion generation can be offloaded to cheaper hardware, while the intelligent synthesis can be reserved for the premium hardware hosting the main model, but embodiments are not limited thereto.

Various experiments were carried out against related art methods to evaluate the results of the MOO method according to embodiments.

As shown in Table I below, the MOO model according to embodiments outperforms other related-art methods.

TABLE I

| | | | |
|---|---|---|---|
| Method | GSM8K | AQuA-RAT | MATH |

Baselines

| | | | |
|---|---|---|---|
| ICL | | | |
| Mistral-7B (v0.2) | 41.90 | 32.87 | 9.10 |
| Mistral-7B (v0.3) | 49.36 | 36.42 | 11.18 |
| Mistral-Nemo | 52.77 | 34.45 | 15.70 |
| Llama-3.2-3B | 66.11 | 40.75 | 30.42 |
| Llama-3-8B | 72.10 | 46.06 | 24.04 |
| Llama-3.1-8B | 73.40 | 47.83 | 29.30 |
| Gemma-2-9B | 80.59 | 57.87 | 41.64 |
| Phi-3-Medium (14B) | 82.26 | 55.12 | 36.24 |
| SFT | | | |
| Llama-3.1-8B | 66.64 | 43.70 | 31.82 |
| Phi-3-Medium (14B) | 82.49 | 57.88 | 41.84 |
| MoA | | | |
| Llama-3.1-8B | 60.27 | 37.99 | 19.74 |
| Phi-3-Medium (14B) | 81.14 | 53.01 | 35.97 |

Ours: Mixture-of-Opinions

| | | | |
|---|---|---|---|
| MoO | | | |
| Llama-3.1-8B | 75.98 | 53.15 | 35.28 |
| Phi-3-Medium (14B) | 85.29 | 62.01 | 42.31 |

To validate the efficacy of the proposed MoO framework, experimental evaluations were conducted across multiple standard benchmarks, including GSM8K, AQUA-RAT, and MATH. Table 1 (discussed herein as a reference to the experimental data) demonstrates that the Mixture of Opinions (MoO) post-training framework consistently improves performance compared to standard baselines.

For example, in an implementation utilizing Llama-3.1-8B as the main model, the MoO framework achieved an accuracy of 75.98% on the GSM8K benchmark, exceeding the 73.46% accuracy achieved by standard In-Context Learning (ICL) with the same model. Furthermore, the MOO approach substantially outperformed both ICL and standard Supervised Fine-Tuning (SFT) baselines on the more complex AQUA-RAT and MATH benchmarks, with similar positive trends observed when utilizing the Phi-3-medium-4 k model (14B).

The experimental results further highlight the distinct advantage of the present MoO framework over other aggregation methods, such as the Mixture of Agents (MoA) approach. While MoA attempts to aggregate responses, the data indicates that it underperforms relative to even the baseline ICL and SFT methods for these specific models, demonstrating that it is not a reliable choice for mathematical reasoning tasks.

In contrast, the MOO framework, by integrating diverse auxiliary opinions directly into the fine-tuning process (post-training), effectively teaches the model to synthesize reasoning paths. This results in a robust improvement in logical problem solving capabilities that existing aggregation or fine-tuning methods fail to achieve.

According to an embodiment, the AI device 100 can be configured to achieve improved mathematical and logical reasoning capabilities suitable for deployment in various types of complex decision making environments, such as scientific research, financial analysis, and automated software engineering. The AI device 100 can be used in various types of different situations.

According to one or more embodiments of the present disclosure, the AI device 100 can solve one or more technological problems in the existing technology, such as implementing a scalable framework for enhancing the mathematical and logical reasoning capabilities of language models. This framework can effectively bridge the performance gap between smaller, open-source models and massive proprietary models by utilizing a mixture of opinions mechanism within a post-training stage to synthesize consistent reasoning paths from multiple ancillary agents to drive a robust main large language model.

For example, embodiments of the present disclosure can address the deficiencies of the related art large language model techniques, which often suffer from reliability issues in complex reasoning tasks (e.g., frequent hallucinations or logical inconsistencies), a dependency on prohibitively expensive computational resources to achieve high accuracy, and the limitations of standard fine-tuning methods that fail to expose the model to the diverse problem solving methodologies for robust generalization.

Also, according to an embodiment, the AI device 100 configured with the reasoning enhancement method can be used in a mobile terminal, a smart TV, a home appliance, a robot, an infotainment system in a vehicle, etc.

For example, the AI device can be applied in a wide range of interactive applications including an intelligent educational tutor, a technical support agent, and a personalized financial advisor.

For example, according to an embodiment, the educational tutor can determine a student's specific point of confusion in a complex math problem, and based on the synthesized reasoning from the framework, the tutor can provide a step-by-step logical explanation that is verified for accuracy, or provide a better answer that addresses the root of the student's misunderstanding rather than just providing a final number.

For example, methods and systems disclosed herein have broad applicability across a wide range of industries and technical fields that utilize generative artificial intelligence for complex problem solving. The reasoning enhanced models trained on the diverse opinion datasets generated by the disclosed pipeline can be well suited for deployment on resource constrained edge devices where high-level logical capability is required but access to massive proprietary cloud models is limited or cost-prohibitive.

Non-limiting examples of such applications include consumer electronics and smart home appliances, such as smart speakers, home automation hubs, personal computers, and mobile devices. The disclosed embodiments can allow manufacturers of such devices to deploy expert level reasoning capabilities directly onto consumer hardware. This enables devices to perform complex multi-step planning (e.g., organizing a schedule based on conflicting constraints) locally, ensuring user privacy by generating reasoned decisions in-house without reliance on third-party cloud API services.

Further, the disclosed method can provide significant advantages for the scientific and engineering industries where robust mathematical precision is desirable for research and development. The trained models can be integrated into simulation software and coding environments to assist with debugging code, interpreting complex datasets, or validating experimental logic. The ability to synthesize multiple reasoning paths allows for the creation of highly reliable research assistants that can identify potential logical fallacies in a hypothesis or catch arithmetic errors that standard models might overlook.

In an enterprise context, the method can be used to develop and train specialized analytic agents for business intelligence, legal contract review, or automated logistics planning, enabling companies to build powerful decision support tools without compromising sensitive corporate data. By utilizing the mixture of opinions framework, an enterprise can fine-tune a smaller, private model to achieve reasoning performance comparable to much larger public models, thereby optimizing both operational costs and data security.

Various aspects of the embodiments described herein can be implemented in a computer-readable medium using, for example, software, hardware, or some combination thereof. For example, the embodiments described herein can be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions can be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

Furthermore, although some aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, Perl, Python, PHP, HTML, or other programming languages. One or more of such software sections or modules can be integrated into a computer system, computer-readable media, or existing communications software.

Although the present disclosure has been described in detail with reference to the representative embodiments, it will be apparent that a person having ordinary skill in the art can carry out various deformations and modifications for the embodiments described as above within the scope without departing from the present disclosure. Therefore, the scope of the present disclosure should not be limited to the aforementioned embodiments, and should be determined by all deformations or modifications derived from the following claims and the equivalent thereof.

What is claimed is:

1. A method for controlling an artificial intelligence (AI) device, the method comprising:
receiving, by a processor in the AI device, a query;
obtaining a plurality of ancillary opinions generated by a plurality of ancillary language models in response to the query, wherein each of the plurality of ancillary opinions includes a chain-of-thought reasoning path derived by a corresponding one of the plurality of ancillary language models and an answer to the query;
constructing an aggregated input sequence including the query and the plurality of ancillary opinions; and
generating, by a fine-tuned main large language model, a final response based on the aggregated input sequence,
wherein the fine-tuned main large language model is fine-tuned to synthesize the plurality of ancillary opinions to derive the final response.

2. The method of claim 1, wherein the fine-tuned main large language model is fine-tuned by a process comprising:
receiving a training dataset including a plurality of training queries and a corresponding ground-truth answer for each of the plurality of training queries;
generating, via the plurality of ancillary language models corresponding to a data curation phase, a plurality of training ancillary opinions for each of the plurality of training queries, wherein each training ancillary opinion includes a reasoning path;
generating augmented training samples for the plurality of training queries by combining a corresponding training query, a corresponding plurality of training ancillary opinions, and the corresponding ground-truth answer for each of the plurality of training queries; and
fine-tuning a main large language model based on the augmented training samples to minimize a loss function to generate the fine-tuned main large language model.

3. The method of claim 2, wherein the fine-tuning the main large language model includes calculating the loss function on tokens corresponding to the ground-truth answer while masking tokens corresponding to the corresponding training query and the corresponding plurality of training ancillary opinions.

4. The method of claim 1, wherein the constructing the aggregated input sequence includes arranging the plurality of ancillary opinions in a fixed order relative to the query, and
wherein the fixed order corresponds to an order used during fine-tuning of the fine-tuned main large language model.

5. The method of claim 1, wherein the constructing the aggregated input sequence includes inserting distinct delimiter tokens to demarcate a start and an end of the plurality of ancillary opinions within the aggregated input sequence.

6. The method of claim 1, wherein the obtaining the plurality of ancillary opinions includes:
retrieving one or more few-shot examples from a training dataset;
appending the one or more few-shot examples to the query to form a prompt; and
transmitting the prompt to the plurality of ancillary language models to elicit the chain-of-thought reasoning path.

7. The method of claim 1, wherein the fine-tuned main large language model has a parameter count that is larger than a parameter count of at least one of the plurality of ancillary language models.

8. The method of claim 1, wherein the plurality of ancillary opinions includes at least one opinion containing a correct reasoning path and at least one opinion containing an incorrect reasoning path, and
wherein the fine-tuned main large language model is configured to distinguish between the correct reasoning path and the incorrect reasoning path to generate the final response.

9. The method of claim 1, wherein the plurality of ancillary language models include a first ancillary model having a first model architecture and a second ancillary model having a second model architecture different from the first model architecture.

10. The method of claim 1, wherein the obtaining the plurality of ancillary opinions includes executing the plurality of ancillary language models in parallel to simultaneously generate the plurality of ancillary opinions.

11. An artificial intelligence (AI) device, comprising:
a memory configured to store information for a large language model; and
a controller configured to:
receive a query,
obtain a plurality of ancillary opinions generated by a plurality of ancillary language models in response to the query, wherein each of the plurality of ancillary opinions includes a chain-of-thought reasoning path derived by a corresponding one of the plurality of ancillary language models and an answer to the query,
construct an aggregated input sequence including the query and the plurality of ancillary opinions, and
generate, by a fine-tuned main large language model, a final response based on the aggregated input sequence,
wherein the fine-tuned main large language model is fine-tuned to synthesize the plurality of ancillary opinions to derive the final response.

12. The AI device of claim 11, wherein the controller is further configured to:
receive a training dataset including a plurality of training queries and a corresponding ground-truth answer for each of the plurality of training queries,
generate, via the plurality of ancillary language models corresponding to a data curation phase, a plurality of training ancillary opinions for each of the plurality of training queries, wherein each training ancillary opinion includes a reasoning path,
generate augmented training samples for the plurality of training queries by combining a corresponding training query, a corresponding plurality of training ancillary opinions, and the corresponding ground-truth answer for each of the plurality of training queries, and
fine-tune a main large language model based on the augmented training samples to minimize a loss function to generate the fine-tuned main large language model.

13. The AI device of claim 12, wherein the controller is further configured to:
calculate the loss function on tokens corresponding to the ground-truth answer while masking tokens corresponding to the corresponding training query and the corresponding plurality of training ancillary opinions.

14. The AI device of claim 11, wherein the controller is further configured to:
arrange the plurality of ancillary opinions in a fixed order relative to the query for constructing the aggregated input sequence,
wherein the fixed order corresponds to an order used during fine-tuning of the fine-tuned main large language model.

15. The AI device of claim 11, wherein the controller is further configured to:
insert distinct delimiter tokens to demarcate a start and an end of the plurality of ancillary opinions within the aggregated input sequence.

16. The AI device of claim 11, wherein the controller is further configured to:
retrieve one or more few-shot examples from a training dataset for obtaining the plurality of ancillary opinions,
append the one or more few-shot examples to the query to form a prompt, and
transmit the prompt to the plurality of ancillary language models to elicit the chain-of-thought reasoning path.

17. The AI device of claim 11, wherein the fine-tuned main large language model has a parameter count that is larger than a parameter count of at least one of the plurality of ancillary language models.

18. The AI device of claim 11, wherein the plurality of ancillary opinions includes at least one opinion containing a correct reasoning path and at least one opinion containing an incorrect reasoning path, and
wherein the fine-tuned main large language model is configured to distinguish between the correct reasoning path and the incorrect reasoning path to generate the final response.

19. The AI device of claim 11, wherein the plurality of ancillary language models include a first ancillary model having a first model architecture and a second ancillary model having a second model architecture different from the first model architecture.

20. A non-transitory computer readable medium storing computer-executable instructions that when executed by a processor, cause the processor to perform the operations of:
receiving a query;
obtaining a plurality of ancillary opinions generated by a plurality of ancillary language models in response to the query, wherein each of the plurality of ancillary opinions includes a chain-of-thought reasoning path derived by a corresponding one of the plurality of ancillary language models and an answer to the query;
constructing an aggregated input sequence including the query and the plurality of ancillary opinions; and
generating, by a fine-tuned main large language model, a final response based on the aggregated input sequence,
wherein the fine-tuned main large language model is fine-tuned to synthesize the plurality of ancillary opinions to derive the final response.
